(19) United States
(12) Patent Application Publication
(10) Pub. No.: US 2002/0189841 A1
(43) Pub. Date: Dec. 19, 2002

(54) Connectionless data link assembly

(76) Inventor: Jack D. Patterson, Kalamazoo, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/881,536

(22) Filed: Jun. 14, 2001

(51) Int. Cl. H01B 3/00

(52) U.S. Cl. 174/72 A

(57) ABSTRACT

A pre-assembled, connectionless data link assembly provides electronic communication between the engine controller and the transmission controller. The connectionless data link assembly comprises a back bone or trunk portion and one or more stub branches spliced into the trunk portion. An engine shunt portion and a transmission shunt portion are spliced into the trunk portion to provide electronic communication to engine and transmission controllers, respectively. In addition, an anti-lock brake system shunt portion can be spliced into the trunk portion. A pair of termination resistors housed in a barrel mold is located at each ends of the data link assembly. In addition, an anti-lock shunt portion may be sliced into the trunk portion to provide communication to an anti-lock brake controller. The pre-assembled, connectionless data link assembly is easily connected to provide electronic communication between the engine, transmission and anti-lock braking system, thereby eliminating the human factor involved with inline connections necessary with conventional data links.

### BACKGROUND OF THE INVENTION

1. Field of the Invention

The invention relates in general to a vehicle drivetrain with an electronic control unit and a data link, and in particular to a pre-assembled, connectionless data link assembly that provides electronic communication between the electronic control unit and the engine controller, the transmission controller, and the anti-lock brake system controller.

2. Description of the Related Art

Typically, a vehicle drivetrain includes a range-type compound transmission and an electronically controlled internal combustion engine. The compound transmission comprises a multiple speed main transmission section connected in series with a range type auxiliary section. The transmission is retained within a housing and includes an input shaft driven by a prime mover, such as diesel engine, through a selectively disengaged, normally engaged friction master clutch. The clutch has an input or driving portion drivingly connected to the engine crankshaft and a driven portion rotatably fixed to the transmission input shaft.

Usually, the engine is fuel throttle controlled, preferably electronically, and is connected to an electronic data link of the type defined in SAE J1922 and/or SAE J1939 protocol, and the master clutch may be manually controlled by a clutch pedal and the like. The master clutch, if used in fully automatic transmission systems, may be automatically controlled, see U.S. Pat. Nos. 4,081,065 and 4,361,060, the disclosures of which are incorporated herein by reference. Alternatively, fuel modulation (as disclosed in U.S. Pat. No. 4,850,236 and incorporated herein by reference) may be utilized for shifting without releasing the master clutch.

The electronically controlled engine is usually provided with its own electronic control unit (ECU). An input shaft brake may be incorporated that provides quicker manual upshifting as is well known in the prior art. It is understood that a data link or databus complying with SAE J1922, SAE J1939, CAN and/or ISO 11898 protocols, or similar protocols, carries information indicative of engine torque, engine speed, transmission output shaft speed, and brake information.

Assembly line workers at the production facility must correctly make at least sixteen connections to properly install the data link. Because the data link provides electronic communication between the engine, transmission and anti-lock braking system, proper installation of the data link is crucial to proper operation of the vehicle. However, proper installation of the data link using such a “building block” design rarely occurs, thereby causing problems with vehicle operation.

The inventor of the present invention has recognized several problems associated with the modular “building block” design of the conventional data link. One problem associated with the conventional data link is that the modular design requires a customized design for every combination of chassis, engine, and auto-mechanical transmission. As a result, the modular data link design requires a large numbers of parts in inventory, thereby increasing the difficulty with manufacture and the costs associated with manufacture of the data link.

Another problem recognized by the inventor is the human factor associated with the assembly of the modular data link. As noted above, the conventional data link design is difficult to assembly because of the large number of connections to install the data link, thereby increasing the likelihood of improper connections, the omission of parts, and the installation of wrong parts. For example, too many or too few terminating resistors may be installed, or the terminating resistors may be installed at the wrong locations.

Even if the data link is assembled with all of the correct parts and the connections are properly made, an assembly line worker can accidentally connect the data link to the chassis at the wrong location. As a result, the data link can be stretched and/or bent, causing the data link to function improperly, if at all.

### SUMMARY OF THE INVENTION

To solve these and other problems, the present invention is directed to a pre-assembled, connectionless data link assembly for providing electronic communication between the engine controller and the transmission controller in which potential human error of assembly is virtually eliminated. The pre-assembled data link assembly comprises a back bone or trunk portion. A stub branch or an engine shunt portion is spliced into the trunk portion to provide electronic communication to an engine controller. A stub branch or transmission shunt portion is spliced into the trunk portion to provide electronic communication to the automated mechanical transmission. A pair of termination resistors are spliced into at the engine shunt portion and the transmission shunt portion. In addition, a stub branch or an anti-lock shunt portion may be sliced into the trunk portion to provide communication to an anti-lock brake controller.

The pre-assembled data link design of the invention does not require a custom design for every combination of chassis, engine, and auto-mechanical transmission, thereby reducing costs associated with the data link. The pre-assembled data link is easily connected to provide electronic communication between the engine, transmission and anti-lock braking system, thereby eliminating the problems associated with incorrect assembly, as in conventional data links.

### BRIEF DESCRIPTION OF THE DRAWINGS

In the drawings:

FIG. 1 is a schematic illustration, in block diagram format, of an automated mechanical transmission system utilizing the data link of the invention.

FIG. 2 is a plan view of a conventional data link using “T” connectors for electronically connecting the engine, transmission and anti-lock brake system.

FIG. 3 is a plan view of a connectionless data link for electronically connection the engine, transmission and anti-lock brake system according to the invention.

### DESCRIPTION OF THE PREFERRED EMBODIMENT

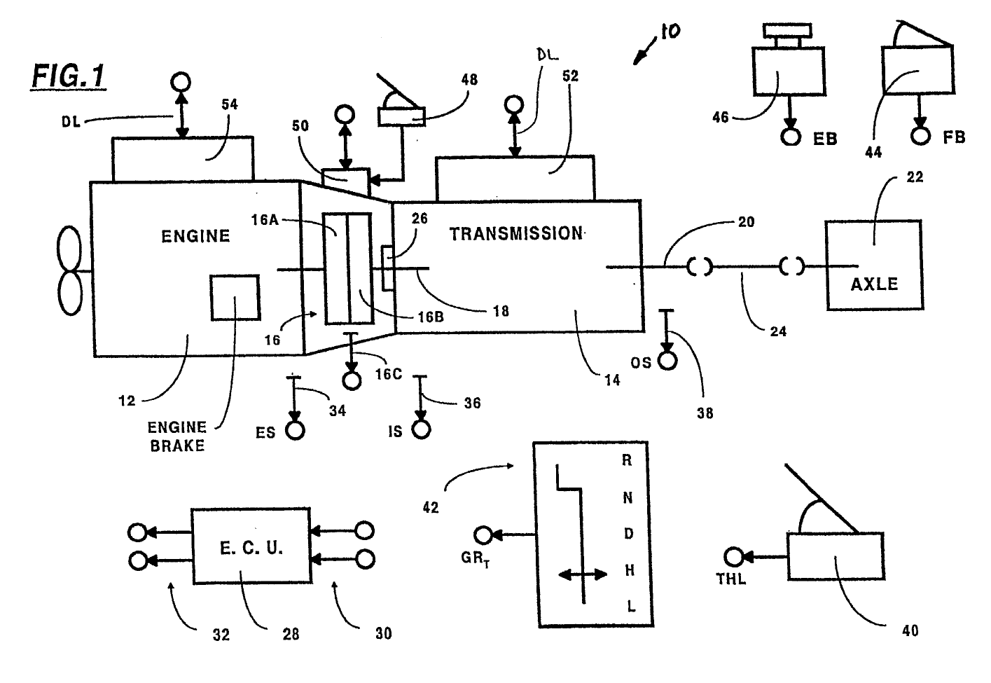

Referring to FIG. 1, a vehicle drivetrain including an at least partially automated mechanical transmission system 10 intended for vehicular use is schematically illustrated. The automated transmission system 10 includes a fuel-controlled engine 12 (such as a well-known diesel engine or the like), a multiple-speed, change-gear transmission 14, and a non-positive coupling 16 (such as a friction master clutch) drivingly interposed between the engine and the input shaft 18 of the transmission. The transmission 14 may be of the compound type comprising a main transmission section connected in series with a splitter-and/or range-type auxiliary section. Transmissions of this type, especially as used with heavy-duty vehicles, typically have 6, 7, 8, 9, 10, 12, 13, 16 or 18 forward speeds. Examples of such transmissions may be seen by reference to U.S. Pat. Nos. 5,390,561 and 5,737,978, the disclosures of which are incorporated herein by reference.

A transmission output shaft 20 extends outwardly from the transmission 14 and is drivingly connected with the vehicle drive axles 22, usually by means of a prop shaft 24. The illustrated master friction clutch 16 includes a driving portion 16A connected to the engine crankshaft/flywheel and a driven portion 16B coupled to the transmission input shaft 18 and adapted to frictionally engage the driving portion 16A. See U.S. Pat. Nos. 5,634,541; 5,450,934 and 5,908,100, herein incorporated by reference. An upshift brake 26 (also known as an input shaft brake or inertia brake) may be used for selectively decelerating the rotational speed of the input shaft 18 for more rapid upshifting, as is well known. Input shaft or upshift brakes are known in the prior art, as may be seen by reference to U.S. Pat. Nos. 5,655,407 and 5,713,445, herein incorporated by reference.

A microprocessor-based electronic control unit (or ECU) 28 is provided for receiving input signals 30 and for processing them in accordance with predetermined logic rules to issue command output signals 32 to various system actuators, such as an anti-lock brake system (ABS) or a CTIS system, and the like. Microprocessor-based controllers of this type are well known, and an example thereof may be seen by reference to U.S. Pat. No. 4,595,986, herein incorporated by reference.

System 10 includes a rotational speed sensor 34 for sensing rotational speed of the engine and providing an output signal (ES) indicative thereof, a rotational speed sensor 36 for sensing the rotational speed of the input shaft 18 and providing an output signal (IS) indicative thereof, and a rotational speed sensor 38 for sensing the rotational speed of the output shaft 20 and providing an output signal (OS) indicative thereof. A sensor 40 may be provided for sensing the displacement of the throttle pedal and providing an output signal (THL) indicative thereof. A shift control console 42 may be provided for allowing the operator to select an operating mode of the transmission system and for providing an output signal (GR_{T}) indicative thereof.

As is known, if the clutch is engaged, the rotational speed of the engine may be determined from the speed of the input shaft and/or the speed of the output shaft and the engaged transmission ratio (ES=IS=OS*GR_{T}).

System 10 also may include sensors 44 and 46 for sensing operation of the vehicle foot brake (also called service brake) and engine brakes, respectively, and for providing signals FB and EB, respectively, indicative thereof.

The master clutch 16 may be controlled by a clutch pedal 48 or by a clutch actuator 50 responding to output signals from the ECU 28. Alternatively, an actuator responsive to control output signals may be provided, which may be overridden by operation of the manual clutch pedal. In the preferred embodiment, the clutch is manually controlled and used only to launch and stop the vehicle (see U.S. Pat. Nos. 4,850,236; 5,272,939 and 5,425,689, herein incorporated by reference).

The transmission 14 may include a transmission controller 52, which responds to output signals from the ECU 28 and/or which sends input signals to the ECU 28 indicative of the selected position thereof. Shift mechanisms of this type, often of the so-called X-Y shifter type, are known in the prior art, as may be seen by reference to U.S. Pat. Nos. 5,305,240 and 5,219,391, herein incorporated by reference. Actuator 52 may shift the main and/or auxiliary section of transmission 14. The engaged and disengaged (i.e., “not engaged”) condition of clutch 16 maybe sensed by a position sensor 16C or may be determined by comparing the speeds of the engine (ES) and the input shaft (IS).

Preferably, fueling of the engine 12 is preferably controlled by an electronic engine controller 54, which accepts command signals from and/or provides input signals to the ECU 28 through the data link DL by using well-known industry protocols such as SAE J1922, SAE J1939, CAN and/or ISO 11898 and the like. Similarly, the transmission 14 is preferably controlled by the transmission actuator 52, which accepts commands from and/or provides input signals to the ECU 28 through the data link DL. Alternatively, a separate ECU for controlling the transmission 14 may be provided.

As shown in FIG. 2, a conventional data link is of a modular design that must be assembled by workers at the vehicle assembly facility. Typically, the data link, such as a type that conforms to the SAE J-1939/11 standard, includes a plurality of backbone connectors 62, a plurality of stub branches 64 plugged into the backbone connectors 62 by the use of “T” connectors 66. A terminating resistor 68 must be plugged into each end of the modular, conventional data link. A battery ground 69 is provided to adequately ground the data link. As is readily apparent from FIG. 2, the conventional data link design is difficult to assemble because of the large number of connections to install the data link, thereby increasing the likelihood of improper connections, the omission of parts, and the installation of wrong parts.

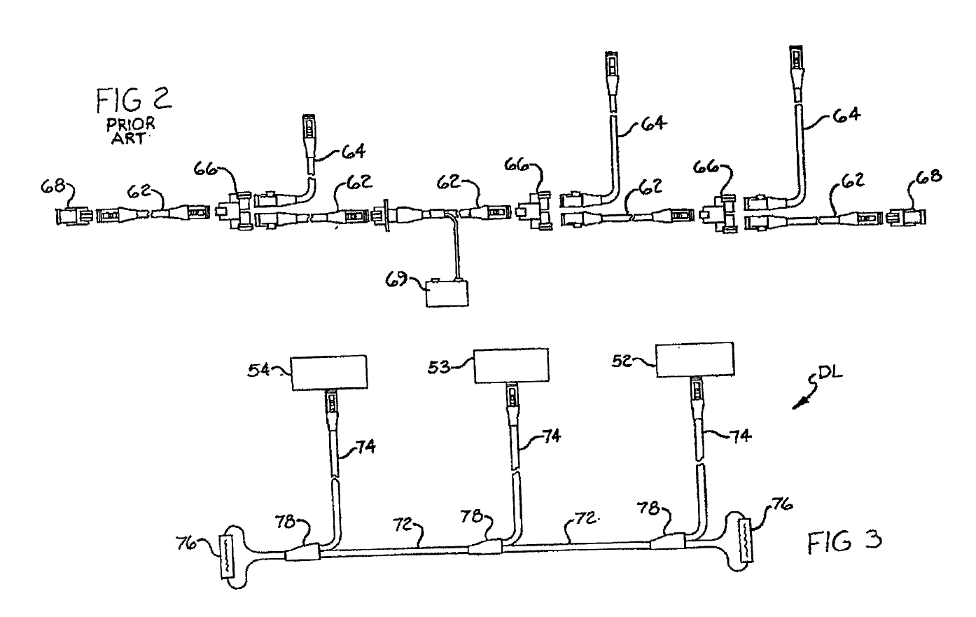

Referring now to FIG. 3, a pre-assembled, connectionless data link assembly DL for electronically connecting the engine controller 54, the transmission controller 52, a controller 53 for an anti-lock brake system, and the like, according to an embodiment of the invention is illustrated. The connectionless data link assembly DL comprises a shunt harness formed by a trunk portion 72 and one or more shunt portions 74 spliced into the trunk portion 72. The trunk portion 72 and shunt portions preferably comprise a multiplex cable conforming to SAE J-1939/15 and SAE J-1939/18 standards, such as a type commercially available from Champlain Cable of Perrysburg, Ohio sold under the trade name RADOX. It will be appreciated that the invention is not limited by the number of shunt portions 74 that are spliced into the trunk portion 72, and that the principles of the invention can be practiced with any desired number of shunt portions 74 that can be spliced into the trunk portion 72 to electrically connect a corresponding number of electronic devices.

Preferably, a double wall shrink tube 78 covers the splice between the trunk portion 72 and the shunt portions 74. One side of the double wall shrink tube 78 has an adhesive thereon to securely cover the splice between the trunk portion 72 and the shunt portions 74. A pair of termination resistors 76 is spliced into the ends of the data link DL. The termination resistors 76 are preferably 120 ohm, ¼ watt, 5% resistors housed in a barrel mold.

As seen in FIG. 3, the pre-assembled, connectionless data link assembly DL has several advantages over the conventional, modular data link of FIG. 2. One advantage is that the number of connections needed for the data link assembly DL of the invention is drastically reduced as compared to the conventional data link. Another advantage of the data link assembly DL of the invention is that the proper number of terminating resistors 76 are spliced into the trunk portion 72 at the proper locations, as compared to the conventional data link in which the correct number of terminating resistors 68 must be securely plugged into the ends of the data link. Yet another advantage is that the data link assembly DL of the invention can be easily connected to the controllers for the engine, transmission and anti-lock braking system by simply plugging each shunt portion to the appropriate controller, thereby eliminating the human factor involved with inline connections necessary with the conventional data link.

While the invention has been specifically described in connection with certain specific embodiments thereof, it is to be understood that this is by way of illustration and not of limitation, and the scope of the appended claims should be construed as broadly as the prior art will permit.

What is claimed is:

1. An electronically controlled vehicle drivetrain, comprising:
an electronically controlled engine including an electronic engine controller;
an electronically controlled automated mechanical transmission including an electronic transmission controller;
a pre-assembled data link assembly for providing electronic communication between said engine controller and said transmission controller, said pre-assembled data link assembly comprising a trunk portion having first and second ends, an engine shunt portion spliced into said trunk portion, a transmission shunt portion spliced into said trunk portion, a first termination resistor located at said first end of said trunk portion, and a second termination resistor located at said second end of said trunk portion.

2. The vehicle drivetrain according to claim 1, wherein said trunk portion comprises a multiplex cable.

3. The vehicle drivetrain according to claim 1, wherein said first and second termination resistors are housed in a barrel mold.

4. The vehicle drivetrain according to claim 1, further comprising a double wall shrink tube for covering said engine shunt portion and said transmission shunt portion.

5. The vehicle drivetrain according to claim 4, wherein one side of said double wall shrink tube includes an adhesive material.

6. The vehicle drivetrain according to claim 1, further comprising an anti-lock brake system shunt portion spliced into said trunk portion.

7. A pre-assembled data link assembly for providing electronic communication between one of an engine controller and a transmission controller, comprising:
a trunk portion having a first end and a second end;
an engine shunt portion spliced into said trunk portion;
a transmission shunt portion spliced into said trunk portion;
a first termination resistor located at the first end of said trunk portion; and
a second termination resistor located at the second end of said trunk portion.

8. The data link assembly according to claim 7, wherein said trunk portion comprises a multiplex cable.

9. The data link assembly according to claim 7, wherein said first and second termination resistors are housed in a barrel mold.

10. The data link assembly according to claim 7, further comprising a double wall shrink tube for covering said engine shunt portion and said transmission shunt portion.

11. The data link assembly according to claim 10, wherein one side of said double wall shrink tube includes an adhesive material.

12. The data link assembly according to claim 7, further comprising an anti-lock brake system shunt portion spliced into said trunk portion.

12. A method for forming a pre-assembled data link assembly for providing electronic communication between one of an engine controller and a transmission controller, comprising the step of:
providing a trunk portion having a first and second ends;
splicing an engine shunt portion into said trunk portion;
splicing a transmission shunt portion into said trunk portion;
terminating the first end of said trunk portion with a first termination resistor; and
terminating the second end of said trunk portion with a second termination resistor.

13. The method according to claim 12, further comprising the step of housing said first and second termination resistors in a barrel mold.

14. The method according to claim 12, further comprising the step of covering said engine shunt portion and said transmission shunt portion with a double wall shrink tube.

15. The method according to claim 12, further comprising the step of splicing an anti-lock brake system shunt portion into said trunk portion.
